(19) United States
(12) Patent Application Publication
(10) Pub. No.: US 2008/0006473 A1
(43) Pub. Date: Jan. 10, 2008

(54) Vehicle mounted device

(75) Inventors: Hiroki Matsuzawa, Kariya-city (JP); Yasushi Ohasi, Kariya-city (JP); Masaaki Imai, Chiryu-city (JP); Izuho Murakami, Ichinomiya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/281,448

(22) Filed: Nov. 18, 2005

(30) Foreign Application Priority Data
Nov. 25, 2004 (JP) 2004-340940

(51) Int. Cl. G10K 11/00

(52) U.S. Cl. 181/.5; 181/200

(57) ABSTRACT

A device for a vehicle has a casing, which is provided with a noise isolation member for obstructing gaps between openings and connectors, gaps at engagement positions and gaps at screw holes, for example. Thus, noise transmitted to passengers in the vehicle from the device can be reduced. The noise isolation member is resilient at the part obstructing the gaps, without hindrance to connection of the connector.

### CROSS REFERENCE TO RELATED APPLICATION

This application is based on a Japanese Patent Application No. 2004-340940 filed on Nov. 25, 2004, the disclosure of which is incorporated herein by reference.

### FIELD OF THE INVENTION

The present invention relates to a vehicle-mounted device, which is provided with a noise reduction member.

### BACKGROUND OF THE INVENTION

There exists a tendency to provide a high-performance IC for a vehicle-mounted vehicle (which is mounted at a vehicle) such as a navigation device, considering an electronization and a performance enhancement of the vehicle. The high-performance IC having a high heat generation rate can be cooled by, for example, a small-sized cooling fan, so that a steady operation of the high-performance IC is maintained. Moreover, the vehicle may be provided with, for example, an apparatus which has an embedded DVD player to display map date using a DVD media.

Wind noise from the cooling fan constructs a noise source for passengers in the vehicle. The cooling fan, the DVD player or the like is provided with a small-sized motor which generates noise due to operation and driving transmission. Furthermore, the DVD player is provided with various driving units for DVD insertion and the like. The driving units also construct the noise source.

For example, referring to JP-2003-11736A, a noise control in the vehicle is provided. In this case, a hand-free microphone of a vehicle telephone is accommodated in a vehicle-mounted control module, thus restricted from picking up ambient noise.

However, in this case, noise from the vehicle-mounted device is not actively isolated from the passenger. In the case where the vehicle-mounted device is fixed to the vehicle, the vehicle-mounted device may have a resonance with the vehicle which is vibration-excited due to a traveling condition (e.g., uneven road surface). Thus, noise from the vehicle-mounted device will be augmented.

As a noise control method, the structure of the noise source apparatus (e.g., motor) can be changed, so that the natural frequency of the noise source apparatus staggers the vibration frequency of the vehicle. Thus, the resonance is avoided. However, the vibration of the vehicle due to the traveling condition is random vibration to have uncertain vibration frequency. Therefore, an active real-time change of the natural frequency of the noise source apparatus according to the vibration frequency of the vehicle is impracticable.

### SUMMARY OF THE INVENTION

In view of the above-described disadvantages, it is an object of the present invention to reduce noise which is transmitted to a passenger in a vehicle from a vehicle-mounted device, for example, a navigation device.

According to the present invention, a device for a vehicle has a casing with at least one gap, and a noise reduction member for reducing noise which is transmitted to an exterior of the casing having at least one noise source therein. The noise reduction member is attached to the casing and obstructs the gap. The noise reduction member is resilient at least at a part thereof which obstructs the gap.

Thus, noise transmitted to the passenger in the vehicle from the device can be reduced. Because the noise-reduction member is resilient at the part blocking the gap, a hindrance to connection of a connector or the like (which is arranged at opening where gap is formed) can be restricted.

### BRIEF DESCRIPTION OF THE DRAWINGS

Other objects, features and advantages of the present invention will become more apparent from the following detailed description made with reference to the accompanying drawings, in which:

FIG. 1A is a schematic view showing a vehicle-mounted device without a noise isolation member, which is viewed from a rear side and a slightly upper side, and FIG. 1B is a schematic view showing the vehicle-mounted device in FIG. 1A, which is provided with the noise isolation member according to a preferred embodiment of the present invention;

FIG. 2A is a schematic view showing the vehicle-mounted device without a noise isolation member, which is viewed from a right side and a slightly lower side, and FIG. 2B is a schematic view showing the vehicle-mounted device in FIG. 2A, which is provided with the noise isolation member according to the preferred embodiment;

FIG. 3 is a schematic view showing an experiment arrangement according to the preferred embodiment; and

FIG. 4 is a graph showing an experiment result according to the preferred embodiment.

### DETAILED DESCRIPTION OF THE PREFERRED EMBODIMENT

### Preferred Embodiment

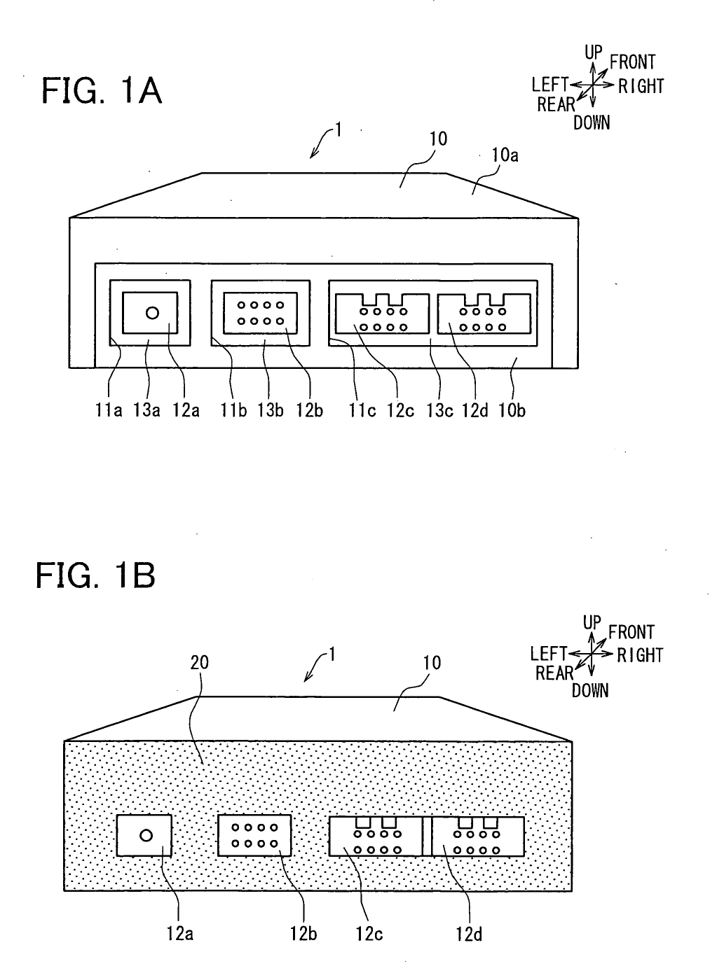

A vehicle-mounted device 1 (device for vehicle) according to a preferred embodiment of the present invention will be described with reference to FIGS. 1-4. The vehicle-mounted device 1 (e.g., navigation device) which is mounted at a vehicle has a casing 10 for accommodating components of the vehicle-mounted device 1, for example, a map data input unit, a control unit and a cooling fan, which are not shown.

Various data memorized in a map memory medium (not shown) can be input into the control unit through the map data input unit. The data include map data, guide voice data, voice identification data and the like. The map memory medium can be classified into a CD-ROM, a DVD, a hard disk and the like. In this embodiment, the DVD is used as the map memory medium, so that the map data input unit as a DVD player can also replay a DVD in which data other than the map data are memorized.

The control unit can be constructed of a well-known microcomputer including a CPU, ROM, RAM, I/O and the like which are communicated with each other through bus line. The control unit performs various processes, for example, a display process and a route guide process based on programs memorized in the ROM and RAM.

In the display process, the control unit calculates the current position along with the coordinates and the traveling direction of the vehicle based on detection signals from position detection units (not shown), and displays the map around the current position at a display (not shown). In this case, the control unit reads in the map through the map data input unit.

In the route guide process, the control unit calculates an optimal route from the current position of the vehicle to the aim position, based on the map data of the current position (which are read in through map data input unit) and the aim position which can be set through multiple operation switches, a remote control or the like (not shown). Thus, the vehicle is guided according to the calculated optimal route.

The cooling fan is provided to mainly cool the control unit. It is preferable to provide a high-performance IC for the control unit, so that the performance of the navigation device 1 can be enhanced. In this case, the control unit has a high heat generation ratio, and is to be cooled by the cooling fan or the like.

A motor and a driving transmission mechanism for driving the cooling fan, those for driving a DVD insertion portion of the DVD player, and the like are also accommodated in the casing 10.

As shown in FIG. 1A, the casing 10 is constructed of an upper casing portion 10a and a lower casing portion 10b. Multiple (e.g., three) openings 11a, 11b and 11c for accommodating connectors 12a, 12b, 12c and 12d are formed at a rear surface of the casing 10, and sequentially located from a lift side and right side in FIG. 1A. The connector 12a for inputting signals of a GPS tuner (not shown) is arranged at the opening 11a. The connector 12b for inputting signals of a VICS tuner (not shown) is arranged at the opening 11b disposed between the connectors 12a and 12c. The connector 12d (being power supply connector) and the connector 12c for connecting the display with a speaker are arranged at the opening 11c.

The connectors 12a, 12b, 12c and 12d of the vehicle-mounted device 1 are connected with other connectors provided for exterior devices (e.g., GPS tuner, VICS tuner, display, speaker and power supply). Gaps 13a, 13b and 13c are respectively formed between the opening 11a and the connector 12a, between the opening 11b and the connector 12b, between the opening 11c and the connectors 12c, 12d, for connection of the connectors.

A front surface (opposite to rear surface) of the vehicle-mounted device 1 is provided with an opening for accommodating the DVD and the like.

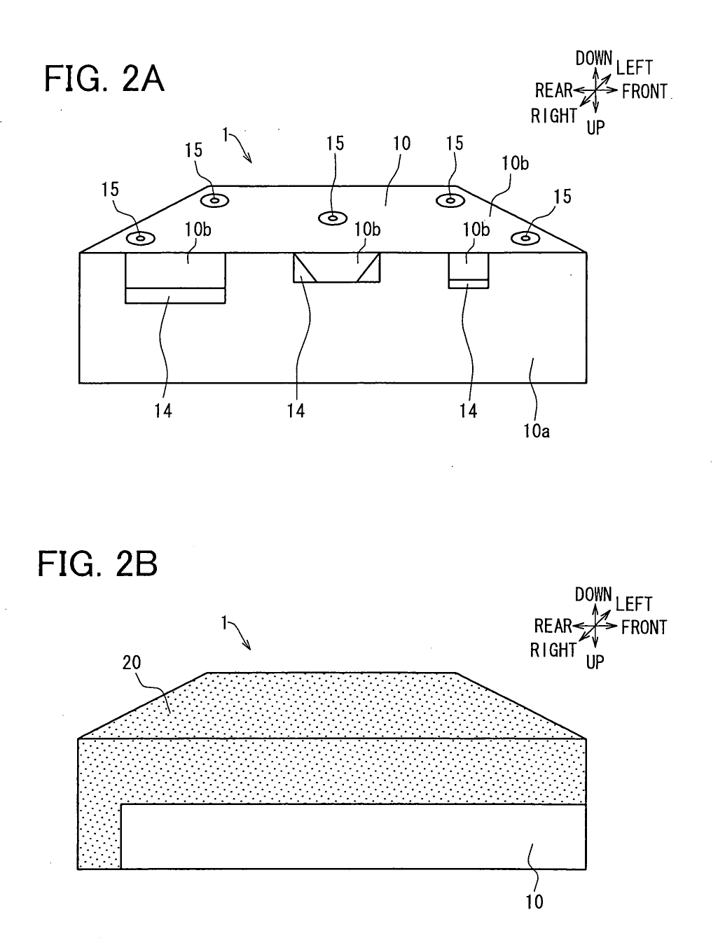

Referring to FIG. 2A, the casing 10 is constructed of the upper casing portion 10a and the lower casing portion 10b, which are engaged with each other at three engagement positions of a right surface and three engagement positions of a left surface of the casing 10. There exists a gap 14 disposed at each of the engagement positions, and formed between the upper casing portion 10a and the lower casing portion 10b. The right surface and the left surface of the casing 10 can be provided with the same construction.

The lower casing portion 10b is provided with multiple fixing holes positioned at a surface thereof, which constructs a bottom surface of the casing 10. A fastening unit such as a screw is accommodated in the fixing hole. In this case, a gap 15 is formed at the fixing hole (screw hole) after fastening through the screws.

As described above, there exist the gaps 13a-13c between the openings 11a-11c and the connectors 12a-12d of the side of the vehicle-mounted device 1, and the gaps 14 at the engagement positions (where upper casing portion 10a is engaged with lower casing portion 10b) and the gaps 15 at the screw holes. Therefore, noise generated in the casing 10 can leak out of the casing 10 through the gaps 13a-15. The noise generated in the casing 10 includes wind noise of the cooing fan, rotation noise of the motor, wobbly operation noise of the mechanism for transmitting driving force of the motor to the cooling fan, and the like.

According to this embodiment, referring to FIG. 1B and FIG. 2B, a noise reduction member 20 (e.g., noise isolation member) is attached to the outer surface (or inner surface) of the casing 10 to obstruct (stop up) the gaps 13a-15. Thus, the noise generated in the casing 10 can be isolated from the exterior.

Specifically, as shown in FIG. 1B, the rear surface of the casing 10 is provided with the noise isolation member 20. In this case, only the connectors 12a-12d are exposed out of the noise isolation member 20. The gaps 13a-13c between the openings 11a-11c and the connectors 12a-12d are obstructed.

Referring to FIG. 2B, the right and left surfaces of the casing 10 are provided with the noise isolation member 20. Thus, the gaps 14 located at the engagement positions (where upper casing portion 10a is engaged with lower casing portion 10b) are blocked. The right and left surfaces of the casing 10 can be partially covered by the noise isolation member 120 (as shown in FIG. 2A) considering a mounting at the vehicle, on condition that at least the gaps 14 are obstructed. However, the whole of the left and right surfaces of the casing 10 can be also covered by the noise isolation member 20. The whole bottom surface (including gaps 15) of the casing 10 is covered by the noise isolation member 20.

Alternatively, the arrangement range of the noise isolation material 20 at the casing 10 can be also set so that at least the gaps 13a-15 are obstructed considering noise isolation. However, in this case, multiple parts of the noise isolation member 20 are to be individually bonded to the casing 10, so that the mounting performance is worsened. In the case where the noise isolation member 20 is attached to the casing 10 to cover the range shown in FIG. 1B and FIG. 2B, the noise isolation member 20 can be constructed of a single part. Thus, the attachment of the noise isolation member 20 to the casing 10 can be simplified.

The noise isolation member 20 is made of a material capable of isolating noise, for example, PORON manufactured by Rogers-INOAC Corporation. The PORON is a urethane foam sponge material having a relatively high stiffness. The PORON has not only a noise isolation performance but also a relatively high resilience, so that the operation performance of connection of the connectors can be maintained due to resilient deformation of the PORON which blocks the gaps 13a-13c.

If the noise isolation member 20 is made of a material (e.g., rubber) having a relatively high friction coefficient, a relatively large friction force will be exerted at the exterior connectors (which are to be connected with connectors 12a-12c of the side of vehicle-mounted device 1) in insertion through the gaps 13a-13c. Therefore, the insertion operation performance will be worsened.

Therefore, the noise isolation member 20 is preferably made of a material having a low friction coefficient so that a hindrance to the connectors when contacting the noise isolation member 20 can be reduced. Because the PORON has the relatively low friction coefficient, the worsening of the operation performance can be restricted.

Moreover, because the PORON has a low compression set, the gaps 13a-15 can be satisfactorily obstructed. Furthermore, the PORON has no migration on other materials, without influencing environment.

As a control method of the noise from the apparatuses including the motor in the casing 10, the structure of the apparatus can be changed so that the natural frequency thereof staggers the vibration frequency of the vehicle. Thus, the resonance of the apparatus and the vehicle can be avoided. However, because the vibration of the vehicle due to the traveling condition (e.g., uneven road surface) is random vibration to have uncertain vibration frequency, the real-time change of the natural frequency of the apparatus according to the vibration frequency of the vehicle is impracticable.

According to this embodiment, the vehicle-mounted device 1 can be readily noise-isolated by the noise isolation member 20 which is attached to the casing 10 to block the gaps 13a-15. Moreover, because the noise isolation member 20 can be arranged to the whole surface of the casing 10, the various noise source apparatuses (e.g., motor and cooling fan) in the casing 10 can be collectively noise-isolated from the exterior, without being noise-controlled individually.

According to this embodiment, the noise isolation member 20 is provided to block the gaps 13a-15 formed at the casing 10, so that noise generated by the noise source apparatuses therein can be restricted from leaking through the gaps 13a-15. Therefore, noise transmitted from the vehicle-mounted device 1 to the passengers in the vehicle can be reduced.

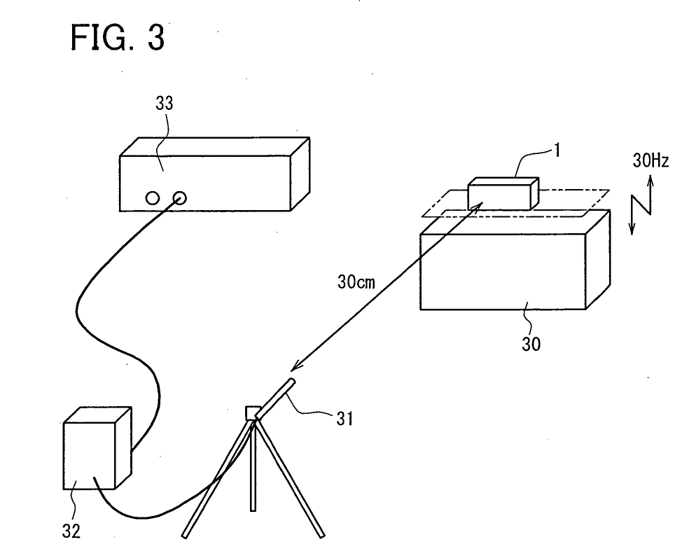

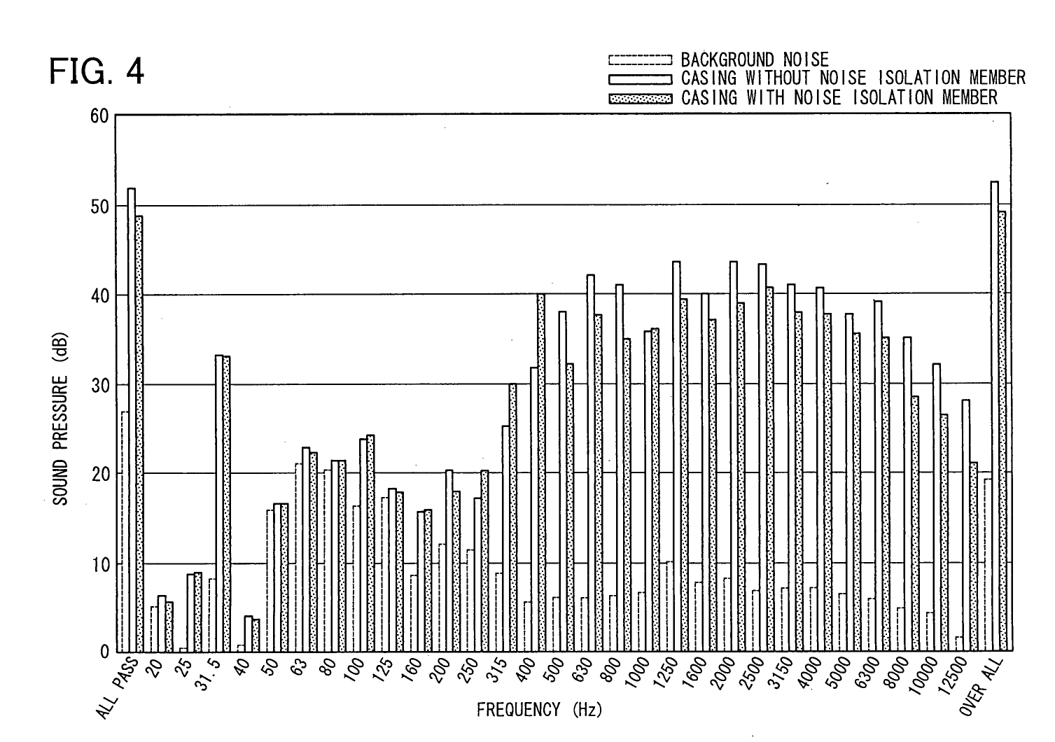

The experiment for verifying the noise isolation effect of the noise isolation member 20 attached to the vehicle-mounted device 1 according to this embodiment will be described referring to FIGS. 3 and 4.

FIG. 3 shows the experiment arrangement. The tested device is the vehicle-mounted device 1 (e.g., navigation device of a DVD-insertion type). The experiment equipments include an exciter 30 (vibration exciting apparatus), a microphone 31, a sound pressure measuring apparatus 32 and a FFT analyzer 33. The experiment is performed at a dead room. The noise isolation member 20 used in the experiment is made of the microcellular polymer sheet PORON (manufactured by Rogers-INOAC Corporation) having a manufacture number “L32” of standard “1” and series “STD”. The noise isolation member 20 has a thickness 4 mm.

In the experiment, the vehicle-mounted device 1 in which the DVD is inserted is compulsorily vibration-excited by the exciter 30. The noise generated by the vehicle-mounted device 1 is picked up (detected) by the microphone 31 which is connected (communicated) with the sound pressure measuring apparatus 32. The sound pressure of the noise is measured by the sound pressure measuring apparatus 32, and FFT-analyzed by the FFT analyzer 33. The FFT analysis result of the sound pressure is graphed by a computer (not shown). The experiment procedure is described as follows.

(1) Fix the vehicle-mounted device 1 to the exciter 30.

(2) Arrange the microphone 31 at a position having a same highness with the vehicle-mounted device 1 and having a predetermined distance (e.g., 30 cm) from the front surface of the vehicle-mounted device 1.

(3) Connect the microphone 31, the sound pressure measuring apparatus 32 and the FFT analyzer 33 by cable.

(4) Measure the sound pressure in the dead room, that is, measure the background noise.

(5) Vibration-excite the vehicle-mounted device 1 having the DVD, by the exciter 30. The excitation frequency of the exciter 30 can be set 30 Hz (acceleration of 1.5 G). In this case, the DVD is inserted in the vehicle-mounted device 1 to simulate an actual use condition in the vehicle.

The vehicle-mounted device 1 provided with the noise isolation member 20 and that without the noise isolation member 20 are respectively vibration-excited as described above.

(6) Pick up the noise from the vibrating vehicle-mounted device 1 using the microphone 31, and detect the sound pressure of the noise by the sound pressure measuring apparatus 32. The sound pressure data are FFT-analyzed in the FFT analyzer 33. Thus, the sound pressure level data of the noise are obtained.

(7) Graph the sound pressure level data of the background noise, the sound pressure level data of the vehicle-mounted device 1 without the noise isolation member 20, and the sound pressure level data of the vehicle-mounted device 1 provided with the noise isolation member 20, as shown in FIG. 4.

In FIG. 4, the longitudinal axis represents sound pressure (dB), and the lateral axis represents frequency (Hz). The sound pressure level data of the background noise are indicated by broken-line bar graphs. The sound pressure level data of the vehicle-mounted device 1 without the noise isolation member 20 are indicated by outline bar graphs. The sound pressure level data of the vehicle-mounted device 1 having the noise isolation member 20 are indicated by dotted bar graphs.

As shown in FIG. 4, the sound pressure level of the vehicle-mounted device 1 provided with the noise isolation member 20 is decreased as compared with that without the noise isolation member 20, especially, in the high frequency band from 500 Hz to 12500 Hz.

Therefore, according to this embodiment, the noise from the vehicle-mounted device 1 can be substantially isolated especially in the high frequency band, by attachment of the noise isolation member 20 to the casing 10.

### Other Embodiment

Although the present invention has been fully described in connection with the preferred embodiments thereof with reference to the accompanying drawings, it is to be noted that various changes and modifications will become apparent to those skilled in the art.

In the above described embodiment, the navigation device is described as an example of the vehicle-mounted device 1. Because the navigation device is often provided with the high-performance IC to be cooled by the fan or the like, a noise control becomes important for the navigation device. However, the vehicle-mounted device 1 described in the present invention can be also suitably used for other device for the vehicle, which is a noise source for the passengers in the vehicle.

Furthermore, the device 1 provided with the noise reduction member 20 can be any other device which has a noise source therein to be noise-controlled.

Moreover, the noise reduction member 20 can also include a noise-absorbing member, which is attached to the casing 10 to absorb noise from the noise source in the casing 10.

The noise isolation member can be also made of other material than the PORON described in the above embodiment, to isolate noise.

Such changes and modifications are to be understood as being in the scope of the present invention as defined by the appended claims.

What is claimed is:

1. A device for a vehicle, comprising:
a casing having at least one gap; and
a noise reduction member, which is attached to the casing and obstructs the gap to reduce noise transmitted to an exterior of the casing having at least one noise source therein, wherein
the noise reduction member is resilient at least at a part thereof which obstructs the gap.

2. The device according to claim 1, wherein the noise reduction member is a noise isolation member for isolating noise from the exterior of the casing.

3. The device according to claim 1, wherein
at least one of the gaps is formed between a connector and an opening, which is formed at the casing to accommodate the connector.

4. The device according to claim 1, wherein:
the casing is constructed of a plurality of portions which are engaged with each other at engagement positions; and
at least one of the gaps is formed at the engagement position.

5. The device according to claim 1, wherein:
the casing has at least one screw hole for accommodating a fastening unit; and
at least one of the gaps is formed at the screw hole.

6. The device according to claim 1, wherein the noise source is a fan.

7. The device according to claim 1, wherein the noise reduction member is made of a PORON.

8. A navigation device is the device according to claim 1.
